(19) United States
(12) Patent Application Publication
(10) Pub. No.: US 2006/0289650 A1
(43) Pub. Date: Dec. 28, 2006

(54) Networked monitoring system

(75) Inventors: Carl Taylor, Pittsburgh, PA (US); Timur P. Sriharto, Monroeville, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Mobile Aspects, Inc., Pittsburgh, PA (US)

(21) Appl. No.: 11/474,773

(22) Filed: Jun. 26, 2006

Related U.S. Application Data
(60) Provisional application No. 60/694,418, filed on Jun. 27, 2005.

(51) Int. Cl. G06K 7/08; G06K 7/00

(52) U.S. Cl. 235/451; 235/435

(57) ABSTRACT

A wireless networked monitoring system including multiple reader mechanisms for receiving, processing and transmitting signals, each reader mechanism associated with a read zone. Multiple signal emitting devices or tags are positionable within the read zones and emit signals containing data. A central processing device is in wireless communication with the reader mechanisms and receives, processes and transmits signals. In addition, the central processing device communicates with and controls the reader mechanisms and/or signal emitting devices.

### CROSS REFERENCE TO RELATED APPLICATIONS

This application claims priority under 35 U.S.C. § 119(e) from provisional U.S. Patent Application No. 60/694,418, filed Jun. 27, 2005, the contents of which are incorporated herein by reference.

### BACKGROUND OF THE INVENTION

1. Field of the Invention

The present invention is directed to systems and mechanisms, such as systems for use in identifying items in the field of inventory management and identification technologies and, in particular, to a networked monitoring system operating on a wireless platform, such as in a radio frequency communications system.

2. Description of Related Art

In many industrial and service applications, a large variety and quantity of items, equipment, persons and objects must be tracked for a variety of reasons. For example, these items may be tracked so that the user knows when additional items should be obtained or ordered, who is using the items and for what purpose, and for expensive items, a secure tracking system is required. Such tracking systems may also be used for tracking personnel, employees, patients and other persons in order to understand location or other person-specific data. Whether for security purposes or inventory purposes, an identification system must be developed in order to accurately track and manage a large amount of items, typically discrete and small items.

For example, in health care delivery institutions, like hospitals, a large amount of inventory must be controlled throughout their system. Thousands of items move in and out of supply and operating rooms every day, and the system administrators must be sure to know exactly what items are being used, when they are being used, who is using them, and how often. At all times, items must be accounted for, and must be fully stocked. In addition, it is often useful to track patient information, such as location within the hospital, as well as a variety of patient-specific data.

In the field of identification and recognition systems and, for example, in the field of radio frequency (RFID) identification systems, a system must be provided to allow for the communication between a reader/recognizer mechanism and an item, such as a tagged item, person or object. The identification is typically accomplished by generating a field, such as a magnetic field, capable of interacting with and communicating with an identification element, such as a tag with a transponder, positioned on the item. The field can either activate or power the tag, in a passive system, or the tag may include internal power sources to facilitate communications with the system reader/recognizer. The magnetic field is typically generated by applying a current to an antenna, such as an antenna wire and the like. Accordingly, the antenna is powered and emits the field, which is used in identifying object or items within the field.

Often, a large area or facility must be monitored and the items situated throughout the facility tracked. According to the prior art, in order to track people or items over a large system or facility, series reader networks are situated at various “check points” throughout the system. Alternatively, a large, overall reader mechanism, which covers a large area or zone, is utilized. However, the accuracy of such systems is suspect. Further, the use of multiple different reader “check points” throughout the system, or use of a large, overall reading system, is often prohibitively expensive to acquire, install and maintain. For example, using the networked “check points”, a dedicated Internet network must be installed, and dedicated lines and power sources are required where tracking is desired. Accordingly, in such systems, the cost of installation can easily be as much as or more than the hardware itself. There is a need in the art for a simple, standalone, yet networked, wireless reader system for use in tracking items, people and objects over a large area or in a large facility.

### SUMMARY OF THE INVENTION

Therefore, it is an object of the present invention to provide a networked monitoring system that overcomes the deficiencies and drawbacks of the prior art in the field of inventory and identification systems. It is another object of the present invention to provide a networked monitoring system that operates on a wireless communication platform. It is a further object of the present invention to provide a networked monitoring system that is a simple and standalone system that operates over a wireless network. It is a still further object of the present invention to provide a networked monitoring system that can be cost effectively installed and, optionally, operate on a single frequency or multiple frequencies, such as in a radio frequency communications operation. It is yet another object of the present invention to provide a networked monitoring system that allows for communication and data transfer functions between multiple reader or monitoring mechanisms.

Accordingly, the present invention is a wireless networked monitoring system. The system includes multiple reader mechanisms for receiving, processing and transmitting signals, and each of the reader mechanisms is associated with a respective read zone. Multiple signal emitting devices are positionable within at least one read zone of a reader mechanism and emit a signal containing data. A central processing device is in wireless communication with the reader mechanisms and: (i) receives signals from the the reader mechanisms; (ii) processes signals; (iii) transmits signals to the reader mechanisms, or any combination thereof. In addition, the central processing device communicates with and controls the reader mechanisms, the signal emitting devices, or any combination thereof. In one embodiment, the system includes a central hub device in wireless communication with the reader mechanisms and: (i) receives signals from the reader mechanisms; (ii) processes signals; (iii) transmits signals to the reader mechanisms, or any combination thereof. The central processing device is in communication with the central hub device and communicates with and controls the central hub device.

In another aspect, the present invention is directed to a wireless system, which includes at least one reader mechanism for receiving, processing and transmitting signals. A plurality of programmable signal emitting devices are in wireless communication with the reader mechanism, and at least one of the programmable signal emitting devices includes: (i) a memory storage device for storing data; (ii) an emitting device for emitting signals containing data; and (iii) a power device for powering the programmable signal emitting device. A central processing device is in wireless communication with the at least one reader mechanism and: (i) receives signals from the at least one reader mechanism; (ii) processes signals; (iii) transmits signals to the at least one reader mechanism, or any combination thereof. Further, the central processing device communicates with and controls the at least one reader mechanism, at least one of the signal emitting devices, or any combination thereof.

The present invention is further directed to a wireless networked monitoring system that includes multiple programmable reader mechanisms, which receive, process and transmit signals. Each of the reader mechanisms is associated with a respective read zone and at least one of the programmable reader mechanisms includes: (i) a memory storage device for storing data; (ii) an emitting device for emitting signals containing data; and (iii) a power device for providing power to the programmable signal emitting device. Multiple signal emitting devices are positionable within at least one read zone of a reader mechanism and emit a signal containing data. A central processing device is in wireless communication with the reader mechanisms and: (i) receives signals from the reader mechanisms; (ii) processes signals; (iii) transmits signals to the reader mechanisms, or any combination thereof. The central processing device communicates with and controls at least one of the reader mechanisms, at least one of the signal emitting devices, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is schematic view of one embodiment of a networked monitoring system according to the present invention;

FIG. 2 is a schematic view of another embodiment of a networked monitoring system according to the present invention;

FIG. 3 is a schematic view of a further embodiment of a networked monitoring system according to the present invention;

FIG. 4 is a schematic view of a still further embodiment of a networked monitoring system according to the present invention;

FIG. 5 is a schematic view of a signal emitting device of a networked monitoring system according to the present invention;

FIG. 6 is a schematic view of a reader mechanism of a networked monitoring system according to the present invention;

FIG. 7 is a diagram illustrating a communication protocol in one embodiment and mode of a networked monitoring system according to the present invention;

FIG. 8 is a diagram illustrating a transmission protocol in another embodiment and mode of a networked monitoring system according to the present invention;

FIG. 9 is a schematic view of one embodiment of a networked monitoring system according to the present invention during the transmission phase;

FIG. 10 is a schematic view of zone read ranges in another embodiment of a networked monitoring system according to the present invention;

FIG. 11 is a diagram illustrating a transmission and schedule protocol in one embodiment of a networked monitoring system according to the present invention;

FIG. 12 is a schematic view of another embodiment of a networked monitoring system according to the present invention;

FIG. 13 is a schematic view of a reader mechanism data packet in one embodiment of a networked monitoring system according to the present invention; and

FIG. 14 is a schematic view of a signal emitting device data packet in one embodiment of a networked monitoring system according to the present invention.

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention is directed to a networked monitoring system 10 for use in a variety of inventory management and asset tracking systems. In one preferred and non-limiting embodiment, the system 10 operates as a radio frequency identification (RFID) system. However, other wireless data gathering and communications platforms and protocols can be used in connection with the presently-invented system 10. All such platforms, protocols and systems may be used to effectively implement this system 10.

In one embodiment, the system 10 includes multiple reader mechanisms 12, which are capable of receiving, processing and transmitting signals, such as data signals, command signals, etc. While the term “reader” is used herein, such as in connection with the “reader” mechanisms 12, this term is not construed to be limiting. For example, as discussed above, the reader mechanisms 12 are not limited to “readers” used in a radio frequency communications system. Accordingly, these reader mechanisms 12 may be monitoring devices, sensors, data gathering devices and other similar devices and mechanisms, which may operate on a variety of different wireless communications platforms and systems.

In addition, each of these reader mechanisms 12 are associated with a respective read zone 14. Multiple signal emitting devices 16 are positioned or positionable within at least one of the read zones 14 of a respective reader mechanism 12. In addition, these signal emitting devices 16 can emit a signal containing data and other information. In one preferred and non-limiting embodiment, the signal emitting devices 16 are attached to an item, person, patient, object, etc., such that the signal emitted from the signal emitting device 16 contains or includes data pertaining or related to that item, person, patient, object, etc.

A central processing device 18 is in wireless communication with the reader mechanisms 12. Further, the central processing device 18 is configured or programmed to receive signals from the reader mechanisms 12, process these signals and/or transmit signals to one or more of the reader mechanisms 12. In addition, the central processing device 18 is capable of communicating with and controlling one or more of the reader mechanisms 12, and may also be capable of communicating with and controlling the signal emitting devices 16, typically through one of the reader mechanisms 12, and in particular a signal emitting device 16 positioned within a read zone 14 of a specific reader mechanism 12. Such a system 10 is illustrated in FIG. 1 in schematic form.

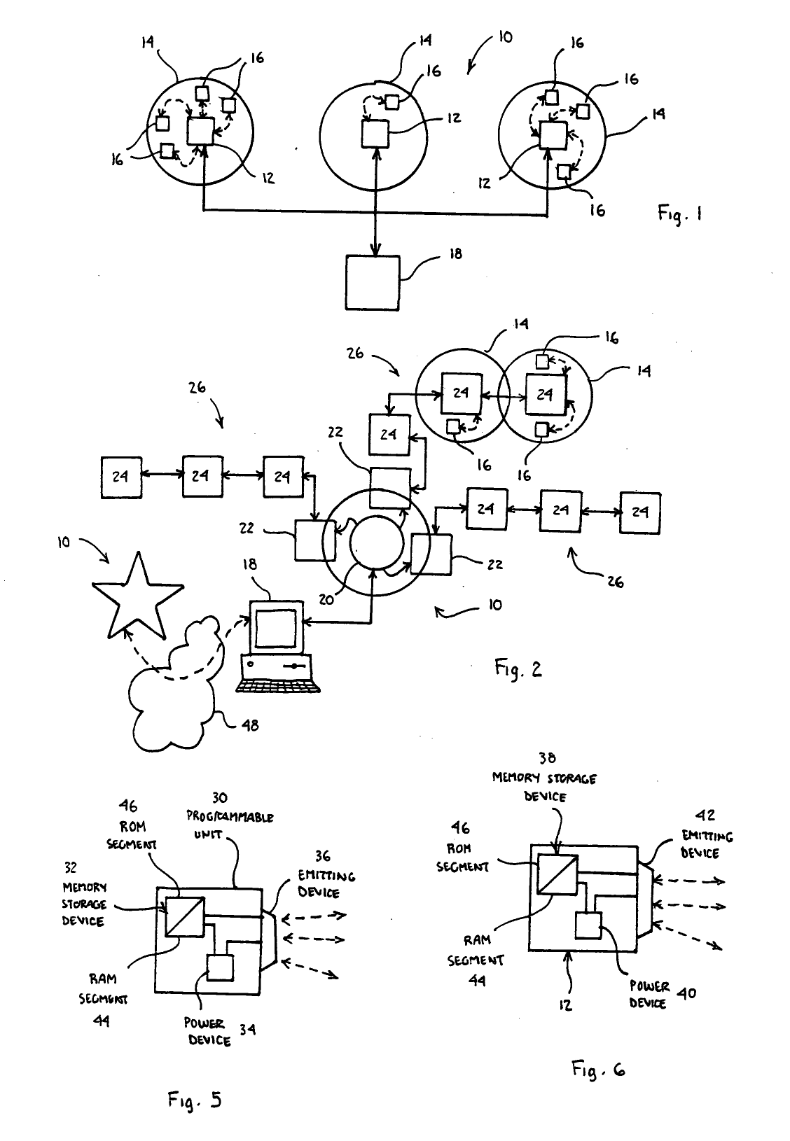

In another embodiment, the system 10 includes a central hub device 20. As illustrated in FIG. 2, the central hub device 20 is in wireless communication with the reader mechanisms 12, and like the central processing device 18, is capable of receiving signals from the reader mechanisms 12, processing these signals and/or transmitting signals to the reader mechanisms 12. In addition, the central processing device 18 is in communication with the central hub device 20, and the central processing device 18 can therefore communicate with and control the central hub device 20.

In this manner, a networked reader system 10 is obtained. In one embodiment, at least one of the reader mechanisms 12 is a reader-to-hub node 22. The reader-to-hub node 22 is in direct communication with both the central hub device 20, as well as at least one other reader mechanism 12, which is referred to as a reader-to-reader node 24. In addition, the reader-to-reader node 24 is in direct communication with at least one other reader mechanism 12, which is also a reader-to-reader node 24. Accordingly, this communication path forms a node serial communication line 26, also referred to as a “link” or “path”.

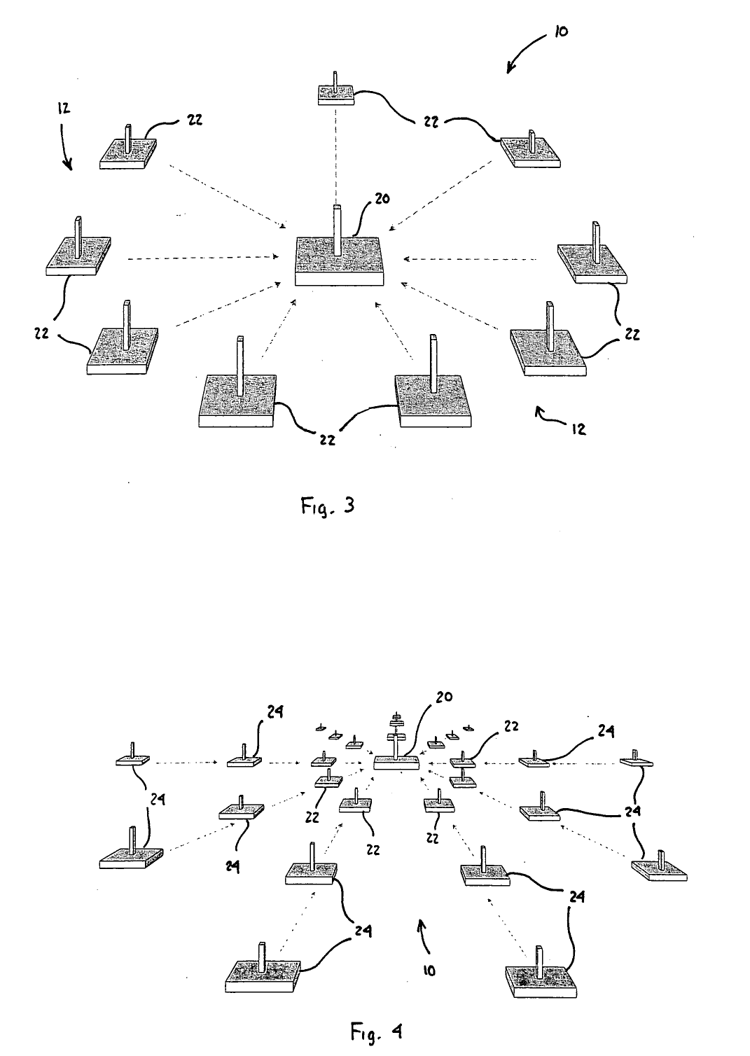

Using this innovative transmission and communication protocol, and through a central command and data source, such as the central processing device 18 and/or the central hub device 20, a variety of “link” structures and communication protocols can be derived. For example, as shown in FIG. 3, a basic star pattern may be achieved by having a single central hub device 20 (which may be in communication with the central processing device 18) in direct communication with multiple reader mechanisms 12, all of which would be reader-to-hub nodes 22. However, as illustrated in FIG. 4, this basic star pattern could be built into an expanded star pattern, where each of the reader-to-hub nodes 22 are in communication with one or more reader-to-reader nodes 24, thereby forming multiple node serial communication lines 26, or “link” arms. In this manner, data can be transmitted and communicated over great distances through the incremental communication from central hub device 20 (and/or central processing device 18), to reader-to-hub node 22, to reader-to-reader node 24, to subsequent reader-to-reader node 24. There is no practical limit to the number of read zones 14, or overall system 10 size, so long as the node serial communication line 26 remains intact and viable.

In order to effect this overall communication architecture, and optimally, all communications between the central hub device 20 (and/or the central processing device 18), reader-to-hub node 22 and reader-to-reader nodes 24 are in a wireless format. Such a format or protocol would allow for easy installation and obviate the need for hardwired contact, complex structural wiring and associated maintenance. Therefore, in one aspect of the present invention, a wireless RFID networked reader system 10 is provided.

Due to the wireless nature of the presently-invented system 10, and in one preferred and non-limiting embodiment, the central hub device 20 and/or the nodes 22, 24 may be configured or programmed to transmit data to another node 22, 24 and/or the central hub device 20 only during a predetermined time slot 28. By using these predetermined or assigned time slots 28, a transmission cycle may be formed between the nodes 22, 24. This transmission cycle may be repeated continually, periodically or at predetermined times. The reason such a transmission cycle may be established is the avoidance of interference during node 22, 24 communication or signal transmission. During these periods of possible collisions or interference, various nodes 22, 24 and/or the central hub device 20 may be programmed to cease any signal transmission at that frequency, or any frequency. Furthermore, the central hub device 20 and/or the nodes 22, 24 may be configured or programmed to transmit data to another node 22, 24 and/or the central hub device 20 on a listen-before-transmission basis, such that the data is only transmitted when the device detects that there exists no other conflicting or interfering signals prior to transmission. Accordingly, any of the devices or components of the system 10 of the present invention may use this listen-before-transmission technique to avoid interference and collision issues during communications.

As discussed in more detail hereinafter, and in one preferred and non-limiting embodiment, the reader-to-reader nodes 24 and the reader-to-hub nodes 22 may operate in various modes and in various communications cycles. For example, these nodes 22, 24 may operate in a “normal” mode, where the reader mechanism 12 receives signals from any signal emitting devices 16 positioned within the read zone 14, as well as a “transmit/receive” mode, where the reader device 12 receives data signals from or transmits data signals to another reader mechanism 12. Accordingly, the nodes 22, 24 in the “transmit/receive” mode may be in this mode only during one of the predetermined time slots during the transmission cycle between the nodes 22, 24. Still further, the reader-to-reader nodes 24 and reader-to-hub nodes 22 may operate in the “transmit/receive” mode during a “normal” (data collection) cycle or a “propagation” cycle, where data is transmitted from the central processing device 18 and/or the central hub device 20 to at least one of the nodes 22, 24. In this “propagation” cycle, data, such as command data or information data, can be sent along the node serial communication line 26 or “link” arm to reach, command, control or otherwise provide data to a specified node 22, 24. In this manner, data may be transmitted from one node 22, 24 to another node 22, 24 in the node serial communication line 26, thereby communicating and propagating data throughout the system 10.

As discussed above, the signal emitting devices 16 may take many forms. For example, in one embodiment, the signal emitting device 16 is in the form of a programmable unit, wherein data may be transmitted from the node 22, 24 or reader mechanism 12 to the programmable unit (signal emitting device 16) in the reader mechanism 12 read zone 14. Such data may include command signals to effect the status, state and/or mode of the reader mechanisms 12 and/or signal emitting device 16. In another embodiment, these data signals include verification signals to verify the transmitted data, or the status, state and/or mode of the reader mechanisms 12 or signal emitting devices 16. For example, this data may include command data, verification data, clock/timer data, mode data, state data, status data, identification data, link data, node data, data amount, update data, signal emitting device data, reader mechanism data, check data, acknowledge data, no acknowledge data, synchronization data, etc.

In addition, when the signal emitting devices 16 are in the form of programmable units, these units may be programmed to adjust the transmission of signals according to a pattern, a time slot, another programmable unit's transmission, another programmable unit's scheduled transmission, etc. In addition, the programmable unit may be configured or programmed to detect operation of a reader mechanism 12, and prevent signal transmission for a number of time increments corresponding to a generated and modifiable random number. A similar arrangement can be used in connection with the node 22, 24 or reader mechanism 12 transmission of signals. For example, as opposed to using a predetermined time slot to transmit signals or data, the reader mechanism 12 may be programmed or configured to detect conflicting or interfering signal transmission before initiating its own transmission.

The programmable unit 30 may take the form of an active tag or a passive tag. As shown in FIG. 5, when the programmable unit 30 (signal emitting device 16) takes the form of an active tag, the unit 30 would include a memory storage device 32 for storing data, as well as a power device 34 for providing power to the programmable unit 30. The memory storage device 32 may be an external memory device, an internal memory device, a memory portion of a processor component of the programmable unit 30, etc.

In addition, the programmable unit 30 may include a signal emitting/receiving device 36, which is used for transmitting data signals to the nodes 22, 24 or reader mechanisms 12, as well as receiving data signals, command signals and instructions from the nodes 22, 24, reader mechanisms 12, central processing device 18 and/or central hub device 20. While the type of data stored on the memory storage device 32 or transmitted by the unit 30 via the emitting device 36 is virtually unlimited, in one embodiment, the data may include an identification, a unique identification, item data, object data, personal data, patient data, employee data, image data, biometric data, audio visual data, pharmaceutical data, drug/patient interaction data, expiry data, synchronization data, command data, verification data, signal emitting device data, identification data, alert data, battery data, etc. The type of data emitted by the signal emitting device 16 typically has some relationship with or relevance to the item, object, person, patient, employee, etc. to which the signal emitting device 16 (or tag) is affixed or associated with.

As with the programmable unit 30 (or signal emitting device 16), it is further envisioned that the reader mechanism 12 also includes a memory storage device 38, power device 40 and signal emitting/receiving device 42, as discussed above in connection with the programmable unit 30. As with the programmable unit 30, the power device 40 may be used to provide power or current to the memory storage device 38 to maintain data integrity, as well as the emitting device 42 to power the transceiver functionality. Such an arrangement is illustrated in FIG. 6 in schematic form.

Both FIGS. 5 and 6 illustrate some of the additional functionality that can be associated with the memory storage device 32, 38. In particular, these memory storage devices 32, 38 may include a random access memory (RAM) segment 44 and a read only memory (ROM) segment 46. The RAM segment 44 allows for storage of modifiable data, while the ROM segment 46 is preprogrammed with static or unmodifiable data. For example, the ROM segment 46 of the memory storage device 32, 38 may include an identification number (such as a 32-bit identification value) for use in uniquely identifying the signal emitting device 16 and/or the reader mechanism 12. In addition, the RAM segment 44 may be in the form of a 512 KB memory chip. Further, as opposed to being stored in memory, the identification number may be a hard-coded value, a dip-switch on the tag, etc.

In addition, the power device 34, 40 of the signal emitting device 16 (programmable unit 30) and reader mechanism 12 may be in the form of a battery, such as a replaceable battery. Accordingly, it is envisioned that a “low power” indicator device may be used in connection with a signal emitting device 16 and/or the reader mechanisms 12 to provide an indication in visual form, audio form, tactile form, etc. that the battery is reaching a “low power” condition.

As discussed above, the signal emitting devices 16 (or programmable units 30) may take many forms. In one preferred and non-limiting embodiment, the signal emitting device 16 is in the form of an active tag, which, in one embodiment, is 1.5×1×0.5 inches in dimension. A tag of this size could easily be worn on a wrist. The tag could be formed from standard components and may, in one embodiment, constantly transmit its unique identification number. However, the size of the power device 34, such as in the form of a small battery, as well as the constant transmission, would place certain limitations on the power device 34 life, perhaps to under a year. However, such “life” may be acceptable in certain applications. As discussed above, the identification may be in the form of a 32-bit number that is permanently stored in the ROM segment 46 of the memory storage device 32.

The reader mechanism 12 may be in the form of or include an antenna as the signal emitting/receiving device 42. For example, in one embodiment, the antenna may have a length of 7.89 centimeters, and may be in communication with an external power supply of, e.g., 5 volts. Further, in this embodiment, the central processing device 18 may be a personal computer. A variety of communications protocols are envisioned for use in data storage and processing, such as RS232, RS485, Zigbee, etc. In addition, transmission protocol may also be TCP/IP.

The use of the programmable unit 30 or tag as discussed above provides additional functionality and benefits. For example, these tags or signal emitting devices 16 would not have to be removed for additional data entry, nor would they require any form of physical connection to transfer data onto the tags. Since the tags have a memory storage device 32, the tags may work independently of any software database or other system, and may be used in isolated areas where Internet access may not be possible.

In one embodiment, these programmable units 30 or tags may be programmed and updated while in use. Since requiring a user, such as a patient, to go to a programmer or programming “checkpoint” to update their personal data would be unacceptable. These tags use the signal emitting/receiving device 36 to enable communication with the nearest node 22, 24 for programming and configuration purposes.

In one embodiment, the programmable units 30 and specifically the signal emitting/receiving device 36, operates on a frequency of 916 MHz. Accordingly, it does not require any internal initializing protocol, and any “handshaking” between the reader mechanisms 12 and the signal emitting devices 16 is not limited to any particular protocol or ISO standard for transfer purposes.

The use of the memory storage device 32 in connection with the signal emitting devices 16 greatly increases functionality. For example, in one embodiment, the memory storage device 32 is capable of storing all the vital patient information, drug addictions, previous surgeries, a picture for identification, and other pertinent data. It is envisioned that the majority of the patient's information and data could fit on a memory storage device 32 consisting of a 512 KB memory chip.

As discussed above, in one embodiment, the reader mechanisms 12 include transmission capabilities in the form of the signal emitting/receiving device 42, which, in one form, may be a transmitter operating at the 916 MHz frequency. This would allow the signal emitting device 16 data to be updated by any reader mechanism 12 or node 22, 24 in the system 10. In addition, the device 42 would allow for two-way communication between it and the signal emitting device 16, enabling handshaking, as well as data transmission checking algorithms to be implemented.

It is envisioned that the same 512 KB memory chip could be used as the memory storage device 38 which would enable the reader mechanism 12 to store large amounts of data until it has an opportunity to transmit this data through the node serial communication line 26 to another node 22, 24, the central hub device 20 and/or the central processing device 18.

With reference again to FIG. 3, the present invention obviates the need for every access point or reader mechanism 12 to be connected to some central processing device 18. Instead, using the star topology shown in this figure, the center reader mechanism 12 is the central hub device 20. The central hub device 20 is connected to the overall inventory or asset management system either directly or through the central processing device 18, such as on a local area network.

Now with reference to FIG. 4, in order to limit the number of direct access points to the central hub device 20 and/or central processing device 18, the node serial communication lines 26 or “links” are formed. In operation, linked nodes 22, 24 or reader mechanisms 12 pass data obtained, such as through the signal emitting devices 16 in the respective read zone 14, to another node 22, 24 or reader mechanism 12. Obviously, this increases the amount of coverage area while minimizing the number of required control devices or Internet connections. In addition, the present invention is not limited to Internet connections.

One benefit of utilizing the topology and pattern illustrated in FIG. 4 is that a single transmission frequency can be used for all communications. By using the above-discussed timing patterns or transmission time slots, any transmission collisions or interference can be minimized. Accordingly, a scheduled transmission protocol can be used, as well as the positioning and relative read zones 14 of the reader mechanisms 12. For example, the transmission may be broken up into multiple time slots, such as ten time slots. These time slots are evenly distributed slots of time that help organize transmission and receiving between the reader mechanisms 12. In one embodiment, once a transmission cycle completes, it repeats.

As discussed above, the system 10 and/or the reader mechanisms 12 may operate in a variety of modes, such as a “normal” mode and “transmit/receive” mode, and in a variety of cycles, such as a “normal” cycle and a “propagation” cycle, in order to effectively communicate. One exemplary embodiment of the communication protocol used in the “normal” cycle is illustrated in FIG. 7. In this embodiment, nine time slots are used for communication along the node serial communication line 26. Further, in this embodiment, the mode is changed from the “normal” mode to the “transmit/receive” mode. Accordingly, the data collected from “normal” mode monitoring of the signal emitting devices 16 in the read zone 14 of the specified reader mechanism 12 or node 22, 24 is transmitted. In addition, the data obtained may be transferred or transmitted to the central hub device 20 utilizing the minimum amount of time slots.

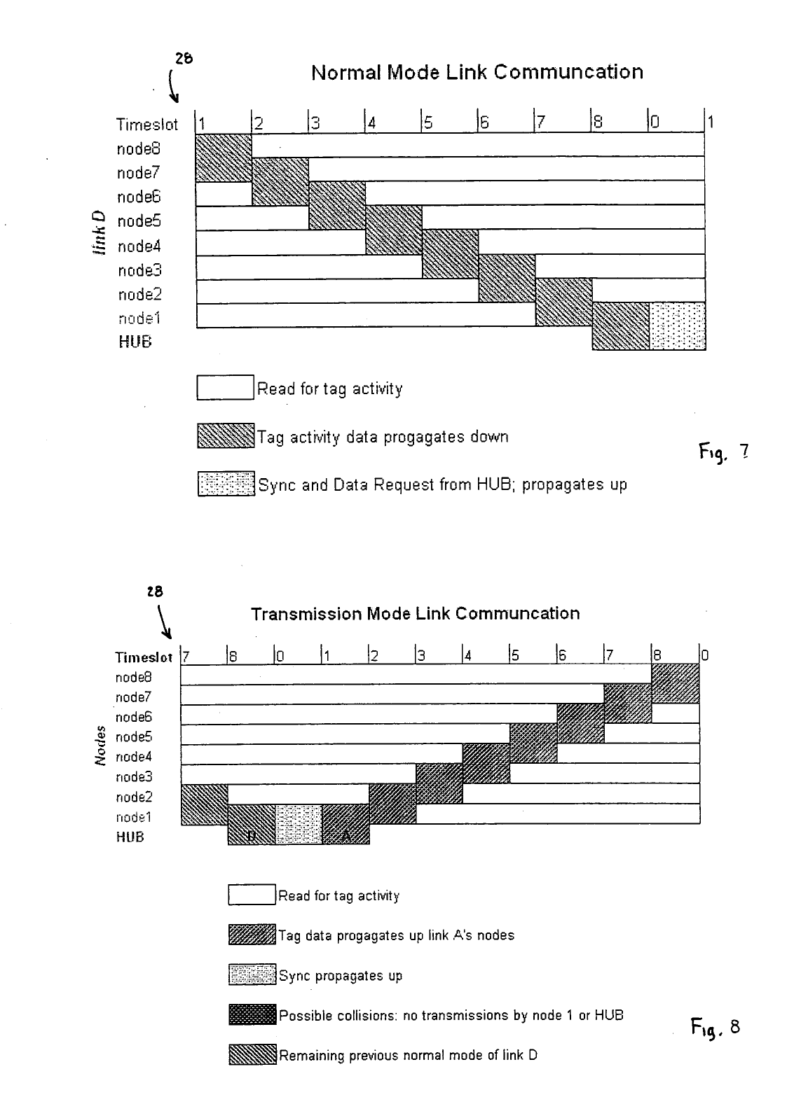

As seen in FIG. 7, the reader mechanism 12 or node 22, 24 uses a pre-assigned time slot to pass data down to the next reader mechanism 12. The reader mechanisms 12 continue to pass the data until it reaches the central hub device 20. The reader mechanisms 12, in this embodiment, only transmit and transfer data during their assigned time slot. This reduces the possibility of interference and collision issues with signal emitting device 16 transmission, as well as other transmission and signals from separate reader mechanisms 12. In addition, transmission during this mode may be also used to synchronize the reader mechanisms 12 with each other, as well as with the signal emitting devices 16 (or tags) in the respective read zone 14. Propagation of data up through the reader mechanisms 12 is illustrated in the “propagation” cycle illustrated in FIG. 8.

As seen in FIGS. 7 and 8, the communication along one node serial communication line 26 is schematically illustrated for a “normal” and “propagation” cycles. Node1 is the closest reader mechanism 12 to the central hub device 20, while node8 is the farthest reader mechanism 12 from the central hub device 20. The synchronization transmission or “propagation” cycle of the central hub device 20 includes a transmission to all “node1” reader mechanisms 12 in the read zone 14 of the central hub device 20. It should also be noted that the signal emitting devices 16 are programmed to cease signal transmission while the reader mechanism 12 in the read zone 14 is in transmit/receive communication with another reader mechanism 12.

In this embodiment, the reader mechanisms 12 also operate in the “transmit/receive” mode, which may be used to program the signal emitting devices 16 and/or the reader mechanisms 12. For example, in this cycle, the system 10 allows the signal emitting devices 16 in any of the read zones 14 within the network to be programmed by the central processing device 18, as well as other computing device connected to some central processing center or other control system. As with the reader mechanisms 12 communications in the “normal” cycle, in the “propagation” cycle, a reverse communication path is utilized, which allows the data to propagate up through the reader mechanisms 12 in a nine-slot cycle. The central processing device 18 transmits data to the central hub device 20 that is in communication with the appropriate node serial communication line 26 having the specified signal emitting device 16 in a particular read zone 14 in this communication line 26. This cycle is illustrated in FIG. 8.

In operation, and in this preferred and non-limiting embodiment, the central hub device 20 signals the reader-to-hub node 22 in the specified node serial communication line 26 that covers the signal emitting device 16 to which data should be transmitted. This reader-to-hub node 22 then sends a command to the next reader-to-reader node 24, which, in turn, continues to move the command through subsequent reader-to-reader nodes 24. This command would configure the reader mechanisms 12 to enter into the “transmit/receive” mode. The data is then sent in the “transmit/receive” mode, and after the data has been transmitted and verified, the node serial communication line 26 (and the reader mechanisms 12 in that line 26) switch back to “normal” mode.

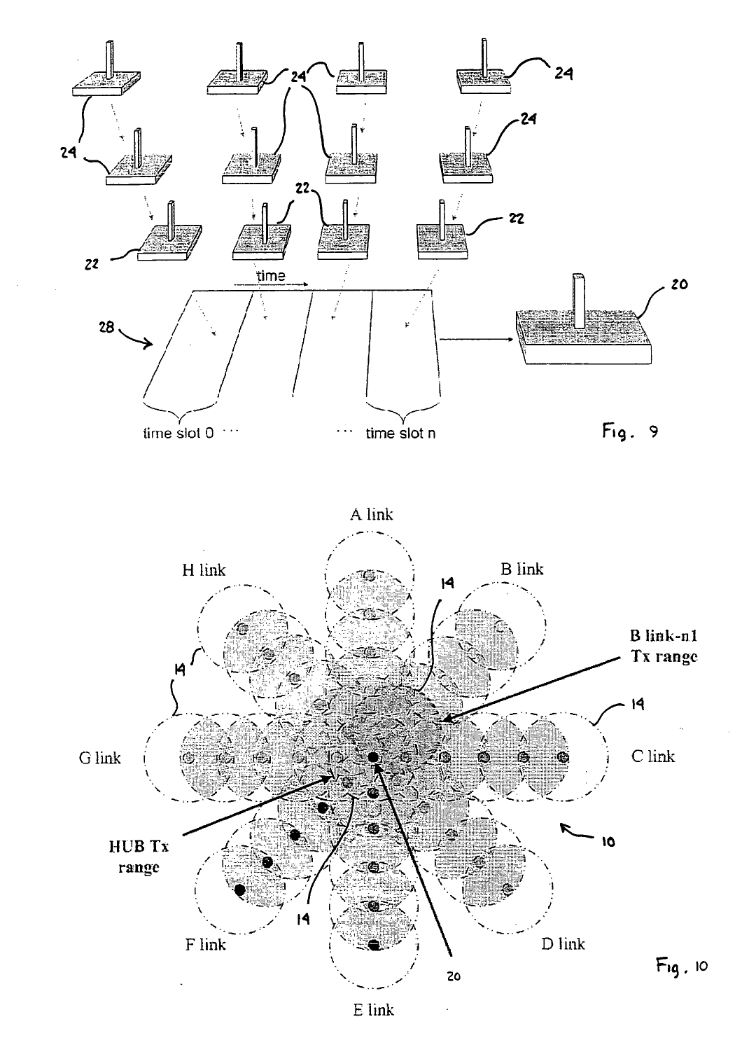

It is envisioned that the amount of data being programmed may require more than one cycle in the “propagation” mode. The number of remaining cycles will be included with the request to switch to the mode. The transmission time schedule for one node serial communication line 26 or “link” is illustrated in FIGS. 8 and 9. It should also be noted that the remaining portion of the “normal” mode illustrated in FIG. 7 from the previous cycle is illustrated at the beginning of FIG. 8. In addition, during the “propagation” cycle, the reader mechanisms 12 may be programmed to continue monitoring for signal emitting device 16 (or tag) activity in the respective read zone 14. The received data will be stored and sent to the central hub device 20 during the “normal” cycle.

The information and data gathered by the reader mechanisms 12 is transmitted down the node serial communication line 26 to the central hub device 20 during the “normal” cycle. In addition, the information or data propagates through the nodes 22, 24, and the reader-to-hub nodes 22 also have assigned communication time slots in which they transmit their information and data to the central hub device 20. For example, such assignments may correspond with the unique identification of the reader mechanism 12. Next, the central hub device 20 would send or transmit the collected data to the central processing device 18, which may then pass it on to some central processing center or other network system.

FIG. 9 illustrates the different node serial communication lines 26 or “links” communicating with the central hub device 20 during their required time slot. Since, in this embodiment, each communication requires two-way transmission (such as an “acknowledged” or “not acknowledged” indication of the previous transmission), and since each reader-to-hub node 22 should be in communication range of the central hub device 20, these reader-to-hub nodes 22 should only transmit during specified time slots, such that no interference or collisions occur. Accordingly, in this embodiment, only one reader-to-hub node 22 may transmit information to the central hub device 20 during any given time slot. When there is a transmission from the reader-to-hub node 22 of any node serial communication line 26, whether or not it is with the central hub device 20 or a subsequent reader-to-reader node 24 in the node serial communication line 26, there is no be additional communications to or from the central hub device 20. Accordingly, transmission overlap must be minimized or obviated. However, as discussed above, the nodes 22, 24 may be operated as a listen-before-transmission component, which also minimizes or obviates transmission overlap.

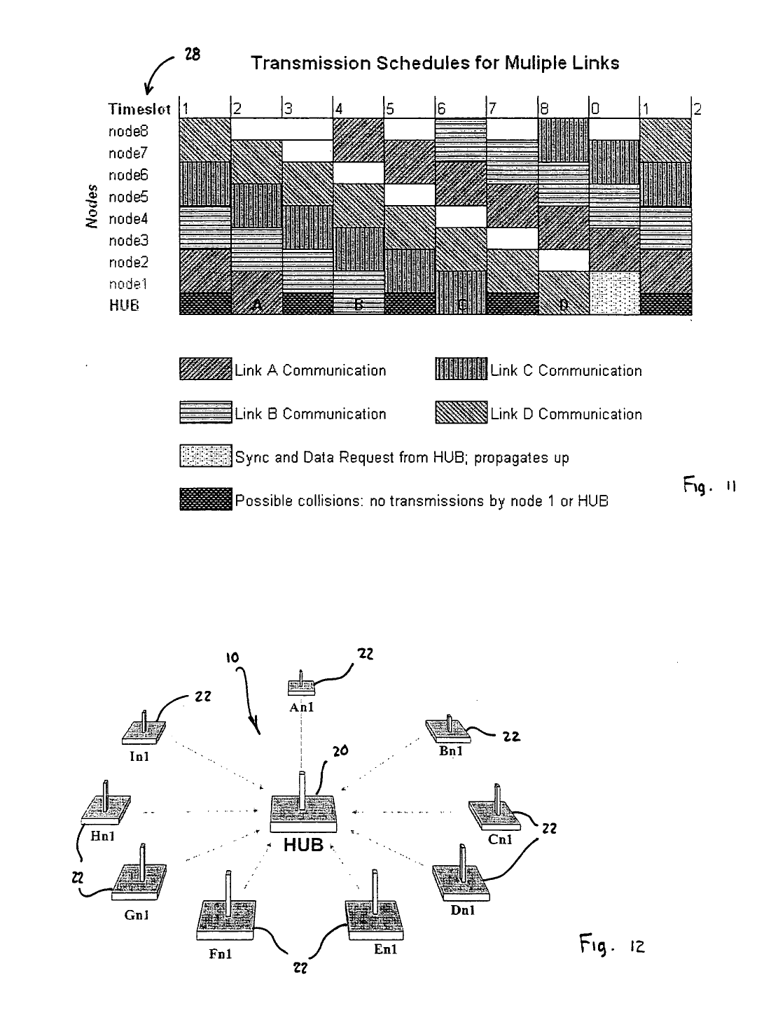

As seen in FIG. 10, and in one preferred and non-limiting embodiment, the central hub device 20 is indicated by the black dot in the center of the diagram. The range of the central hub device 20 must include all of the reader-to-hub nodes 22 of each of the node serial communication line 26. The transmission range of the central hub device 20 is illustrated by the circle surrounding the black dot. In one example, the reader-to-hub node 22 is the first node of node serial communication line 26 or “link” B. Accordingly, the transmission range of this reader-to-hub node 22 and “link” B (which is shaded) must be in transmission range of the central hub device 20, as well as the next reader-to-reader node 24 and the “link”. However, when this node 22, 24 communication is occurring, the transmissions will also reach the central hub device 20. Therefore, no other communication to or from the central hub device 20 should be conducted at the same time. In addition, neighboring nodes 22, 24 in the neighboring node serial communication line 26 may also be affected by transmissions of a nearby “link”, such that these transmissions may also be staggered.

FIG. 11 illustrates the use of a staggered transmission protocol using a nine-time slot timing routine. As illustrated, various collisions may occur, and such collisions may be avoided using this routine. In addition, FIG. 11 illustrates the use of the staggering concept in connection with the node serial communication lines 26 operating in the “normal” cycle. As discussed above, each time the reader-to-hub node 22 communicates with its subsequent reader-to-reader node 24, it is also impacting the central hub device 20. Accordingly, other nodes 22, 24 cannot be communicating with the central hub device 20 during this time slot.

Accordingly, and as illustrated in FIG. 11, node 22, 24 activity is illustrated, with time traveling from left to right. In this embodiment, the time, which has been divided into slots, repeats in a cycle. The number of time steps needed must be greater than X×2+1, where X is the number of node serial communication lines 26 connected to the central hub device 20. The same amount of time is required for a “propagation” and “normal” cycles, and therefore a particular node serial communication line 26 or “link” can switch to “propagation” cycle, while the remaining node serial communication lines 26 can resume the “normal” cycle. The use of this staggered transmission protocol achieves an effective and networked wireless communication platform for the system 10. In addition, such communication forms the wireless star topology illustrated in FIG. 12. Still further, it is envisioned that multiple center hub devices 20 can be utilized in connection with multiple reader mechanisms 12 and node serial communication lines 26 connected to each other.

In one preferred and non-limiting embodiment, the programmable units 30 may include dynamic communication with the reader mechanisms 12 by incorporating the above-discussed listen-before-transmission protocol. Accordingly, the signal emitting devices 16 (or tags) will have the ability to listen for other tags in the read zone 14 and adjust the transmission times accordingly. For example, if two tags try to communicate at the same time, the tags involved may assign themselves a random number, which will give them their transmit order and time slot. The tags will listen for the transmission from the reader mechanism 12 (for purposes of synchronization), then pause for the number of time slots corresponding to the random number assigned to them. If there is another collision, then this process continues until the tag successfully transmits, and then it will continue to transmit during that phase of the cycle. Of course, it is also envisioned that any of the components of the system 10, such as the reader mechanisms 12, nodes 22, 24, etc. may use the listen-before-transmission protocol.

In addition, it is envisioned that the system 10 may not operate on a single frequency, but on multiple frequencies, such as when using radio frequency communications. The primary frequency may be between the central hub device 20, reader-to-hub node 22 and reader-to-reader node 24. The secondary frequency would be used in the communications between the signal emitting device 16 and the reader mechanisms 12. The use of multiple frequencies would simplify the designs and transmission protocols required, however, the use of multiple frequencies may increase the complexity of the components and required mechanisms. It is also envisioned that the signal emitting devices 16 or reader mechanisms 12 operate at differing frequencies, with respect to one another. In another aspect of the system 10 of the present invention, and in another embodiment, the data transmitted through the reader mechanisms 12 to the central hub device 20 may serve to synchronize the clocks of the reader mechanisms 12, inform the system 10 of any faulty reader mechanisms 12, notify the nodes 22, 24 of mode changes, collect signal emitting device 16 (or tag) information and data, acknowledge receipt of data, etc. For example, the reader-to-hub node 22 may initiate the communication, and the reader-to-reader node 24 would pass this information or data along the node serial communication line 26. During the “propagation” cycle, the reader-to-hub node 22 sends a majority of the data, while the reader-to-reader node 24 only sends its status or acknowledgement or non-acknowledgment of receipt.

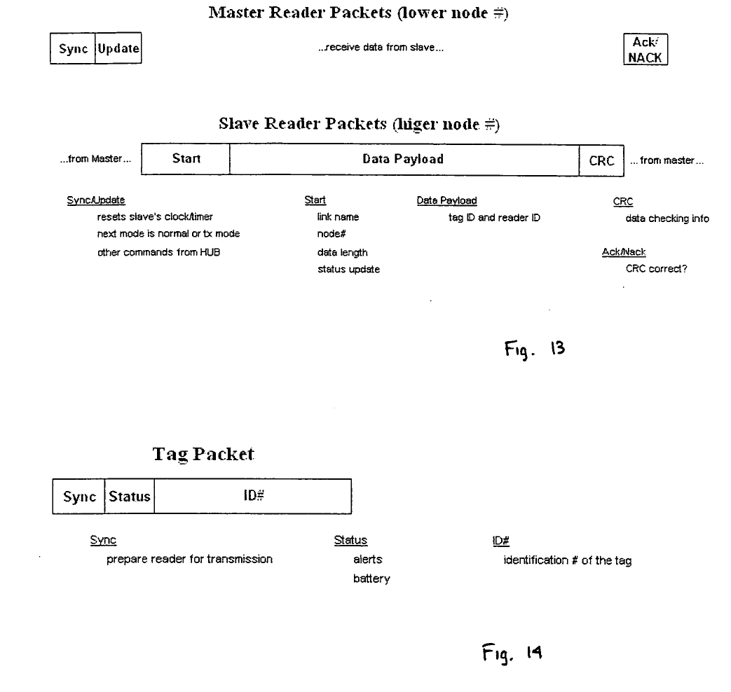

As illustrated in FIG. 13, these data packets may take many forms, and a variety of data fields transmitted. For example, as seen in FIG. 13, the data packet for the “master” or reader-to-hub node 22 includes synchronization/update data, which may reset the clocks/timers of the reader mechanism 12, inform the reader mechanism 12 what is the next mode, or provide other commands, such as commands from the central hub device 20. The “slave” reader mechanism 12 or reader-to-reader node 24 may send a data packet that includes start data (“link”, name, node identification, data length, status update, etc.), data payload information (from the signal emitting devices 16 and/or reader mechanism 12), as well as check data (data checking information, acknowledge signal, non-acknowledgment). In addition, the “master” data packet may include some acknowledgment or non-acknowledgment of transmission receipt.

In one embodiment, the data packets sent from the signal emitting devices 16 to the reader mechanism 12 may contain synchronization data for preparing the reader mechanism 12 for transmission/receipt, status data, such as for alerts, battery conditions, etc., as well as identification data, such as the unique identification of the signal emitting device 16. When used in a single-frequency system, a synchronization byte must be received from the reader mechanism 12, and the reader mechanism 12 must then transmit to or “talk” to the next reader mechanism, such that the signal emitting device 16 (or tag) must wait for another synchronization and data exchange cycle, wherein it can then transmit the data. It is envisioned that approximately 80% of the time may be available to freely transmit data from the signal emitting devices 16 to the reader mechanism 12. However, in a two-frequency system, the signal emitting devices 16 may transmit at any time. In this embodiment, the synchronization data would only be used to inform the reader mechanism 12 that information or data is about to be transmitted.

Again, while specific reference has been made to timed transmissions in a single-frequency system, additional protocols may be utilized, such as the aforementioned listen-before-transmission protocol, which is functional and useful within the wireless network system 10. In addition, each node 22, 24 may be specifically addressed by unique identification during the transmission process, and a multiple-frequency system can also be used for effective communication.

Accordingly, the present invention provides a networked radio frequency identification system 10 that is particularly useful in and on a wireless communication platform. Therefore, hardwired connections are not required, and the presently-invented system 10 provides for appropriate communication to a central source, such as the central processing device 18 or central hub device 20. Therefore, an effective wireless network is provided, and this network is capable of simple and cost-effective installation. The present system 10 may be equally useful in connection with a single or multiple frequency platform. In this manner, the radio frequency identification networked reader system 10 of the present invention allows for effective communication and data transfer functions between a network of reader mechanisms 12.

As discussed above, the central processing device 18 may be in communication with a subsequent inventory management or asset management system. For example, the central processing device 18 may be a networked computer operable to wirelessly (or in a hardwired format) communicate with a central control system. For example, as seen in FIG. 2, multiple systems 10 may be in communication with a central processing device 18, such as over a network 48. In particular, it is the unique advantage of wireless communication that allows the presently-invented system 10 to operate in a variety of configurations. A very large network can be established allowing one or more central processing devices 18 to manage the overall communication and control throughout the various components.

It is also envisioned that this system 10 could be useful in a variety of data-passing and communications systems and in connection with a variety of commercially-available devices and components. For example, a hard-wired reader could be connected to the reader mechanisms 12 (or monitoring/transmission devices) in order to create a wireless network built upon wired devices. Still further, the present system 10 could be used to augment or even replace conventional security systems, where the reader mechanisms 12 are the above-mentioned sensors or monitoring devices.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A wireless radio frequency identification networked reader system, comprising:
a plurality of reader mechanisms configured to receive, process and transmit signals, each of the plurality of reader mechanisms associated with a respective read zone;
a plurality of signal emitting devices positionable within at least one read zone of a reader mechanism and configured to emit a signal containing data;
a central processing device in wireless communication with the plurality of reader mechanisms and configured to: (i) receive signals from the plurality of the reader mechanisms; (ii) process signals; (iii) transmit signals to the plurality of reader mechanisms, or any combination thereof, the central processing device further configured to communicate with and control at least one of the plurality of reader mechanisms, at least one of the plurality of signal emitting devices, or any combination thereof.

2. The system of claim 1, further comprising a central hub device in wireless communication with the plurality of reader mechanisms and configured to: (i) receive signals from the plurality of the reader mechanisms; (ii) process signals; (iii) transmit signals to the plurality of reader mechanisms, or any combination thereof, wherein the central processing device is in communication with the central hub device and further configured to communicate with and control the central hub device.

3. The system of claim 2, wherein at least one of the plurality of reader mechanisms is a reader-to-hub node in direct communication with: (i) the central hub device, and (ii) at least one other reader mechanism, which is a reader-to-reader node.

4. The system of claim 3, wherein the reader-to-reader node is in direct communication with at least one other reader mechanism, which is also a reader-to-reader node, thereby forming a node serial communication line.

5. The system of claim 4, wherein the central hub device, the nodes or any combination thereof are configured to transmit data to another node or the central hub device only during a predetermined time slot, thereby forming a transmission cycle between the nodes.

6. The system of claim 5, wherein the transmission cycle is repeated continually, periodically or at predetermined times.

7. The system of claim 4, wherein the central hub device, the nodes or any combination thereof are configured to transmit data to another node or the central hub device on a listen-before-transmission basis.

8. The system of claim 4, wherein the reader-to-reader and reader-to-hub nodes operate in at least two modes, including: (i) a normal mode, wherein the reader mechanism receives signals from any signal emitting devices positioned within the read zone; and (ii) a transmit/receive mode, wherein the reader mechanism receives data signals from or transmits data signals to another reader mechanism.

9. The system of claim 8, wherein the nodes are in the transmit/receive mode only during a predetermined time slot, thereby forming a transmission cycle between the nodes.

10. The system of claim 8, wherein the reader-to-reader and reader-to-hub nodes operate in a propagation cycle, wherein data is transmitted from the central processing device, the central hub device, or any combination thereof, to at least one of the nodes.

11. The system of claim 10, wherein the data is transmitted from one node to another node, thereby propagating data through the system.

12. The system of claim 10, wherein at least one of the plurality of signal emitting devices is in the form of a programmable unit, wherein the data is transmitted from the at least one node to the programmable unit.

13. The system of claim 10, wherein the data includes command signals configured to effect the status, state, mode or any combination thereof, of at least one of the plurality of reader mechanisms, at least one of the plurality of signal emitting devices, or any combination thereof.

14. The system of claim 10, wherein the data includes verification signals configured to verify: (i) the data; (ii) the status of at least one of the plurality of signal emitting devices; (iii) the state of at least one of the plurality of signal emitting devices; (iv) the mode of at least one of the plurality of signal emitting devices; (v) the status of at least one of the plurality of reader mechanisms; (vi) the state of at least one of the plurality of reader mechanisms; (vii) the mode of at least one of the plurality of reader mechanisms, or any combination thereof.

15. The system of claim 10, wherein the data includes command data, verification data, clock/timer data, mode data, state data, status data, identification data, link data, node data, data amount, update data, signal emitting device data, reader mechanism data, check data, acknowledge data, no acknowledge data, synchronization data, or any combination thereof.

16. The system of claim 2, wherein a plurality of reader mechanisms are reader-to-hub nodes in direct communication with: (i) the central hub device, and (ii) at least one other reader mechanism, which is a reader-to-reader node, and the reader-to-reader node is in direct communication with at least one other reader mechanism, which is a reader-to-reader node, thereby forming a node serial communication line for each reader-to-hub node.

17. The system of claim 16, wherein the nodes are configured to transmit data to another node in the node serial communication line or the central hub device only during a predetermined time slot, thereby forming a transmission cycle between the nodes in each node serial communication line.

18. The system of claim 1, wherein at least one of the plurality of signal emitting devices is in the form of a programmable unit.

19. The system of claim 18, wherein the programmable unit is programmed through direct or indirect communication with at least one of the plurality of reader mechanism, a central hub device, the central processing device, or any combination thereof.

20. The system of claim 18, wherein the programmable unit is programmed to adjust its transmission of signals according to: (i) a pattern; (ii) a time slot; (iii) another programmable unit's transmission; (iv) another programmable unit's scheduled transmission, or any combination thereof.

21. The system of claim 18 wherein the programmable unit is configured to detect operation of a reader mechanism and prevent signal transmission for a number of time increments corresponding to a generated and modifiable random number.

22. The system of claim 18, wherein the programmable unit is in the form of an active tag having a memory storage device for storing data and a power device configured to provide power to the programmable unit.

23. The system of claim 1, wherein the data on the signal emitting device is an identification, a unique identification, item data, object data, personal data, patient data, employee data, image data, biometric data, audiovisual data, pharmaceutical data, drug/patient interaction data, expiry data, synchronization data, command data, verification data, signal emitting device data, identification data, alert data, battery data, or any combination thereof.

24. The system of claim 1, wherein at least one of the plurality of signal emitting devices, at least one of the plurality of reader mechanism, or any combination thereof, is configured to sense a parameter, state, status, transmission, activity, or any combination thereof, prior to transmission of data.

25. A wireless radio frequency identification system, comprising:
at least one reader mechanism configured to receive, process and transmit signals;
a plurality of programmable signal emitting devices in wireless communication with the at least one reader mechanism, at least one of the plurality of programmable signal emitting devices including:
(i) a memory storage device for storing data;
(ii) an emitting device configured to emit signals containing data; and
(iii) a power device configured to provide power to the programmable signal emitting device; and
a central processing device in wireless communication with the at least one reader mechanism and configured to: (i) receive signals from the at least one reader mechanism; (ii) process signals; (iii) transmit signals to the at least one reader mechanism, or any combination thereof, the central processing device further configured to communicate with and control the at least one reader mechanism, at least one of the plurality of signal emitting devices, or any combination thereof.

26. The system of claim 25, wherein the memory storage device includes a random access memory (RAM) segment and a read only memory (ROM) segment, the random access memory segment including modifiable data, and the read only memory including static data.

27. The system of claim 26, wherein the ROM segment includes an identification number for use in uniquely identifying the signal emitting device.

28. A wireless radio frequency identification networked reader system, comprising:
a plurality of programmable reader mechanisms configured to receive, process and transmit signals, each of the plurality of reader mechanisms associated with a respective read zone and at least one of the plurality of programmable reader mechanisms including:
(i) a memory storage device for storing data;
(ii) an emitting device configured to emit signals containing data; and
(iii) a power device configured to provide power to the programmable signal emitting device;
a plurality of signal emitting devices positionable within at least one read zone of a reader mechanism and configured to emit a signal containing data;
a central processing device in wireless communication with the plurality of reader mechanisms and configured to: (i) receive signals from the plurality of the reader mechanisms; (ii) process signals; (iii) transmit signals to the plurality of reader mechanisms, or any combination thereof, the central processing device further configured to communicate with and control at least one of the plurality of reader mechanisms, at least one of the plurality of signal emitting devices, or any combination thereof.

29. The system of claim 28, wherein the power device is a replaceable battery, and the system further comprises a “low power” indicator device configured to provide an indication in a visual form, audio form, tactile form, or any combination thereof.

30. The system of claim 28, wherein at least one of the plurality of the reader mechanisms operates in at least two modes, including: (i) a normal mode, wherein the reader mechanism receives, into the memory storage device, signals from any signal emitting devices positioned within the read zone; and (ii) a transmit/receive mode, wherein the reader mechanism receives data signals from or transmits data signals to another reader mechanism via the emitting device.
